(19) United States
(12) Patent Application Publication
(10) Pub. No.: US 2017/0066194 A1
(43) Pub. Date: Mar. 9, 2017

(54) EXTRUSION NOZZLES, METHODS, AND SYSTEMS FOR THREE-DIMENSIONAL PRINTING

(71) Applicant: EMPIRE TECHNOLOGY DEVELOPMENT LLC, Wilmington, DE (US)

(72) Inventor: Nicholas Sheppard Bromer, Marietta, PA (US)

(73) Assignee: EMPIRE TECHNOLOGY DEVELOPMENT LLC, Wilmington, DE (US)

(21) Appl. No.: 15/123,144

(22) PCT Filed: Mar. 11, 2014
(86) PCT No.: PCT/US2014/023613

§ 371 Date: Sep. 1, 2016

(51) Int. Cl. B29C 67/00; B33Y 30/00; B33Y 50/02; B33Y 10/00

(52) U.S. Cl. CPC B29C 67/0088; B29C 67/0085; B29C 67/0055; B33Y 10/00; B33Y 30/00; B33Y 50/02

(57) ABSTRACT

Technologies are generally described for an extrusion nozzle of a 3D printing system that allows deposition and rapid solidification of a resin layer on a non-uniform substrate surface in order to form a 3D printed article of various shape and size. The extrusion nozzle may include a center tube that facilitates a flow of resin through the center tube to deposit the resin layer on the substrate surface. A second tube may surround the center tube such that a first annular space between the center tube and the second tube is vacuum-insulated to maintain the resin at a constant temperature as it flows through the center tube and is deposited. A third tube may surround the second tube, and guide a deposition of a cooling gas onto the deposited resin layer through a second annular space between the second tube and the third tube to rapidly solidify the resin layer.

### BACKGROUND

Unless otherwise indicated herein, the materials described in this section are not prior art to the claims in this application and are not admitted to be prior art by inclusion in this section.

While the first three-dimensional (3D) printed articles were generally models, the industry is quickly advancing by creating 3D printed articles that may be functional parts in more complex systems, such as hinges, tools, and structural elements. An arising challenge for the advancing industry is the lack of ability to print at non-rectilinear angles, which may limit a shape and structure of the 3D articles to be printed. The shape and structure may further be inhibited by temperature distribution in the 3D printing systems that prevent deposited resin layers from being solidified rapidly enough to create shapes and structures of interest.

Current attempts in 3D printing systems to solve such issues could use improvements and/or alternative or additional solutions to allow rapid solidification of the deposited resin layers and printing at non-rectilinear angles on non-uniform, concave and/or convex substrates to form 3D printed articles of various shapes and sizes.

### SUMMARY

The present disclosure generally describes methods, apparatus, systems, devices, and/or computer program products for an extrusion nozzle in a three dimensional (3D) printing system.

According to some examples, extrusion nozzles for a 3D printing system are described. An example extrusion nozzle may include a vacuum-insulated tube comprising a center tube configured to facilitate a flow of resin therethrough from a first end to a second end thereof, and a second tube surrounding the center tube, where the second tube and the center tube may be arranged such that a first annular space between the center tube and the second tube is vacuum-insulated. The example extrusion nozzle may also include a controller configured to manage a deposition of a layer of the resin onto a surface of a substrate through the center tube.

According to other examples, methods of using an extrusion nozzle in a 3D printing system are provided. An example method may include depositing a layer of resin onto a surface of a substrate through a center tube of the extrusion nozzle, where a second tube surrounding the center tube may be coupled to the center tube such that a first annular space between the center tube and the second tube is vacuum-insulated.

According to further examples, 3D printing systems are described. An example system may include a resin deposition module configured to deposit a layer of resin onto a surface of a substrate through a vacuum-insulated center tube of an extrusion nozzle, where a second tube surrounding the center tube may be coupled to the center tube such that a first annular space between the center tube and the second tube is vacuum-insulated. The example system may also include a controller configured to coordinate operations of the resin deposition module.

According to some embodiments, methods to fabricate an extrusion nozzle for a 3D printing system are provided. An example method may include forming a vacuum-insulated combination tube comprising a center tube configured to facilitate a flow of resin therethrough from a first end to a second end thereof, and a second tube surrounding the center tube, where the second tube and the center tube may be arranged such that a first annular space between the center tube and the second tube is vacuum-insulated. The example method may also include forming a third tube to surround the second tube such that a second annular space between the second tube and the third tube may be configured to facilitate a flow of cooling gas.

According to some embodiments, a computer-readable storage medium with instructions stored thereon to use an extrusion nozzle in a three-dimensional (3D) printing system may be described. The instructions may cause a method, similar to the methods provided above, to be performed when executed.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example configuration of a three-dimensional (3D) printing system;

FIG. 2 illustrates an example of a vacuum-insulated tube of an extrusion nozzle;

FIG. 3 illustrates a cross-section of an extrusion nozzle employed in a 3D printing system;

FIG. 4 illustrates a system to fabricate an extrusion nozzle;

FIG. 5 illustrates a system to employ an extrusion nozzle in a 3D printing system to form a 3D printed article;

FIG. 6 illustrates a general purpose computing device, which may be used to form a 3D printed article employing an extrusion nozzle in a 3D printing system;

FIG. 7 is a flow diagram illustrating an example method to form a 3D printed article employing an extrusion nozzle in a 3D printing system that may be performed by a computing device such as the computing device in FIG. 6; and

FIG. 8 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar articles, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn to methods, apparatus, systems, devices, and/or computer program products related to an extrusion nozzle in a three dimensional (3D) printing system, including fabrication thereof.

Briefly stated, technologies are generally described for an extrusion nozzle of a 3D printing system that allows deposition and rapid solidification of a resin layer on a non-uniform substrate surface in order to form a 3D printed article of various shape and size. The extrusion nozzle may include a center tube that facilitates a flow of resin through the center tube to deposit the resin layer on the substrate surface. A second tube may surround the center tube such that a first annular space between the center tube and the second tube is vacuum-insulated to maintain the resin at a constant temperature as it flows through the center tube and is deposited. A third tube may surround the second tube, and guide a deposition of a cooling gas onto the deposited resin layer through a second annular space between the second tube and the third tube to rapidly solidify the resin layer.

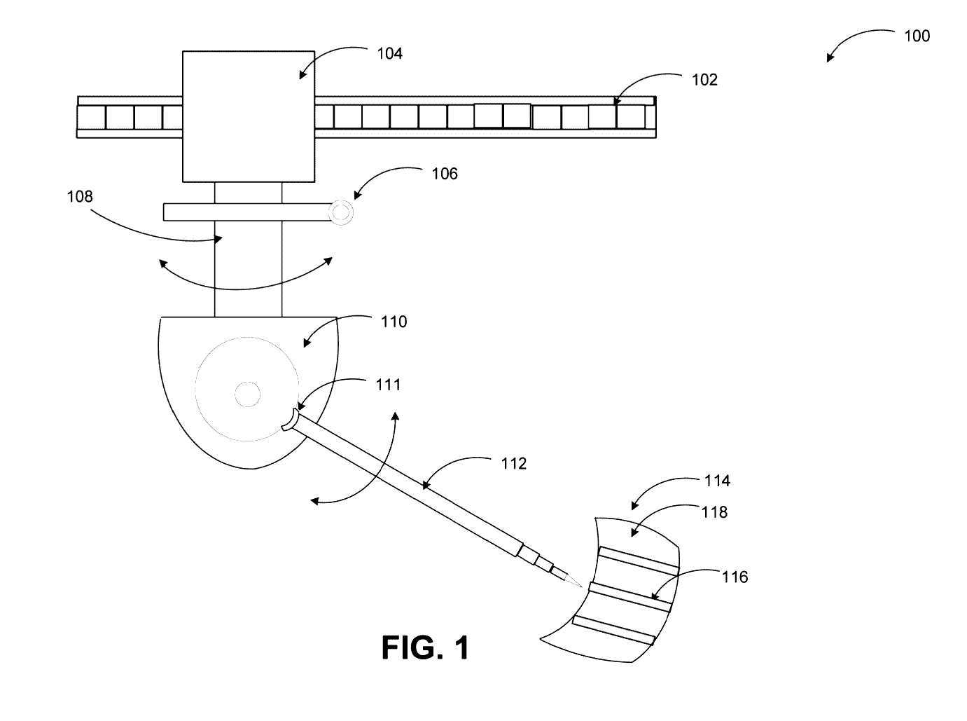

FIG. 1 illustrates an example configuration of a 3D printing system, arranged in accordance with at least some embodiments described herein.

As shown in a diagram 100, an example 3D printing system may include an extrusion nozzle 112 attached to a computer-controlled pivot 108 with one or more servomotors 106, 110 to allow rotation of the extrusion nozzle 112 to various angles both in azimuth and in elevation, as indicated by double-headed arrows. The pivot 108 may be attached to a head-driver rail 104 to allow horizontal traverse along a rail 102. Other components of the 3D printing system may include feedstock and electrical wiring (not shown in FIG. 1).

The extrusion nozzle 112 may include a vacuum-insulated tube comprising a center tube having an interior of an elongated Dewar flask and a second tube surrounding the center tube such that a first annular space between the center tube and the second tube is vacuum-insulated. The vacuum-insulated tube may be configured as an attachable and de-attachable extension of a printhead of the 3D printing system, as illustrated by FIG. 1. For example, the extrusion nozzle 112 may be attached to one of the servomotors (for example, 110) of the printer head with a nut 111. Alternatively, the vacuum-insulated tube may be incorporated into a printhead of the 3D printing system.

The center tube of the extrusion nozzle 112 may be configured to facilitate a flow of resin through the center tube in order to deposit a layer of resin onto a surface of a substrate to form a 3D printed article. A vacuum strength in the first annular space between the center tube and the second tube may be selected such that a temperature of the resin in the center tube remains substantially constant throughout the center tube while the resin is flowing through the center tube, or, may be selected so that the resin remains liquid inside the center tube for some predetermined period of time. The vacuum strength in the first annular space may be selected in a range from about 10⁻¹ torr to about 10⁻⁷ torr, for example, in order to maintain the temperature of the resin at a substantially constant temperature throughout the center tube. Accordingly, the resin may remain at a substantially high temperature throughout the center tube, despite a potential distance from an initial heat source to the extrusion nozzle as the resin flows from the heat source to a tip of the center tube to be deposited. This may allow the extrusion nozzle 12 to be positioned far from a main forming head of a 3D printer, where the heat source may be located. Once the resin layer is deposited onto the surface of the substrate, the resin layer may be rapidly cooled and solidified in the air. In another embodiment, the extrusion nozzle 112 may include a third tube surrounding the second tube that may guide a deposition of a cooling gas onto the resin layer through a second annular space between the second tube and the third tube in order to rapidly solidify the resin layer (not shown in FIG. 1).

Different from current printhead technology, the extrusion nozzle 112 may be positioned to allow resin to be deposited into cavities, crevices, and troughs of substrates. The extrusion nozzle 112 may also be tilted to deposit a layer of resin onto a surface of a substrate that is non-horizontal, non-parallel to a substrate support base, and/or non-parallel to a track by which the extrusion nozzle 112 is moved. For example, using the extrusion nozzle 112, a second resin 116 (for example, of a different color) may be deposited into one or more crevices of a 3D printed article 114, such as a bowl, after the 3D printed article 114 has been formed from a first resin 118. In contrast, current printhead technology may involve frequent switching of the first and second resin deposition, as it deposits the second resin in short segments during repeated horizontal traverses.

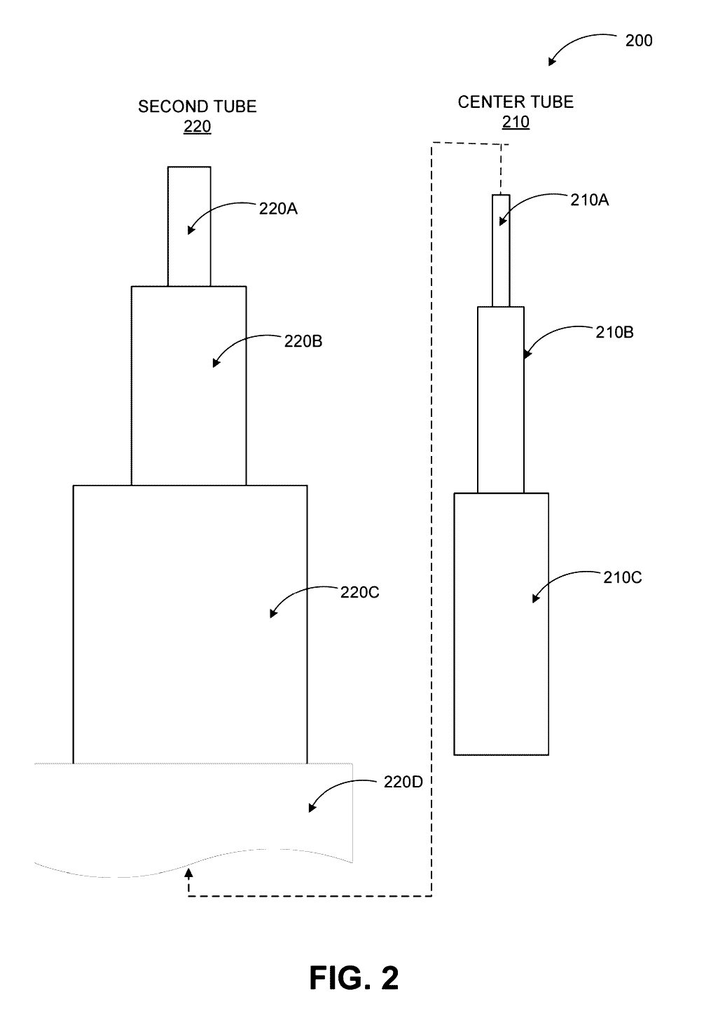

FIG. 2 illustrates an example of a vacuum-insulated tube of an extrusion nozzle, arranged in accordance with at least some embodiments described herein.

As shown in a diagram 200, a vacuum-insulated tube of an extrusion nozzle may include a center tube 210 and a second tube 220. The center tube 210 may have an interior of an elongated Dewar flask, and the second tube 220 may surround the center tube 210 such that a first annular space between the center tube 210 and the second tube 220 is vacuum-insulated.

The center tube 210 and the second tube 220 may be vacuum sealed, crimped, soldered, or welded together at a first end and a second end to form the vacuum-insulated tube. If the center tube 210 and the second tube 220 are vacuum sealed, they may be vacuum sealed together with an epoxy, a silver solder, glass, and/or or another substance that can form an effective vacuum seal. In some embodiments, the center tube 210 and the second tube 220 may be composed of hypodermic stainless steel or glass tubing, where the tubing has relatively low thermal conductivity. However, the tubing need not have low thermal conductivity, and reflectivity may be more important than thermal conductivity for overall insulation effect. Any metal of sufficient strength may be used. In other embodiments, the center tube 210 and the second tube 220 may be composed of non-hypodermic and non-stainless steel tubing composed of any strong metal. The tubing of the center tube 210 and the second tube 220 may be as small in diameter as possible to provide a greater flexibility of the extrusion nozzle for deposition of resin. For example, a tip of the extrusion nozzle may be positioned into a cavity, crevice, or trough of the substrate in order to deposit resin. The tubing of the center tube 210 and the second tube 220 may also be a limited length or a larger internal diameter based on a viscosity-friction resistance of the resin to prevent a high pressure from being needed to force the resin through the tubing.

In some embodiments, the center tube 210 and the second tube 220 may form a set of telescoping tubes. Each tube in the set of telescoping tubes may be vacuum-sealed to an adjacent tube in a similar manner to the vacuum seal of the center tube 210 and the second tube 220, discussed previously. For example, tubes 210A, 210B, and 210 C may form the center tube 210, and tubes 220A, 220B, 220C, and 220D may form the second tube 220. Each tube outside of an inner tube in the set of telescoping tubes may be more rigid than the inner tube and may have a lower resistance to a flow of resin than the inner tube. For example, the tube 210B may be more rigid and have a lower flow resistance than the tube 210 A within the center tube 210.

The center tube 210 of the extrusion nozzle may be configured to facilitate a flow of resin through the center tube 210 in order to deposit a layer of resin onto a surface of a substrate to form a 3D printed article. A vacuum strength in the first annular space between the center tube 210 and the second tube 220 may be selected such that a temperature of the resin in the center tube 210 remains substantially constant throughout the center tube 210 during deposition and between depositions of the resin. The vacuum insulation and the relatively low thermal conductivity of the tubing used may allow the resin layer to be deposited from the center tube 210 of the extrusion nozzle at a high temperature, despite a high surface-to-volume ratio of the center tube 210 and resin accumulated within the center tube 210. Once the resin layer is deposited onto the surface of the substrate, the resin layer may be rapidly cooled and solidified in the air.

In other embodiments, the set of telescoping tubes 210A, 210B, and 210C that form the center tube 210 may be used independent of the second tube 220 to facilitate a flow of resin in order to deposit a resin layer onto a surface of a substrate. An electrical current may be applied through the center tube 210 to one or more return wires near a tip of the center tube 210 to provide heat in order to maintain a high temperature of resin within the tubes in the absence of the vacuum insulation, to augment the vacuum insulation, or to reheat the resin following a long period of time during which the resin is not flowing through the center tube 210. The electrical resistance may increase with decreasing tubing sizes due to reduced cross sections such that the smaller tubes near a tip of the center tube 210 may maintain the resin at a higher temperature. For example, the tube 210A near the tip of the center tube 210 has a smaller cross section than the tube 210B, it will have a greater electrical resistance per unit length (if made of the same material as the tube 210B), and thus will create more heat per unit length if the same electric current is flowing through both tubes 210A and 210B, and therefore maintains the resin at a higher temperature in the tube 210A than in the tube 2101B.

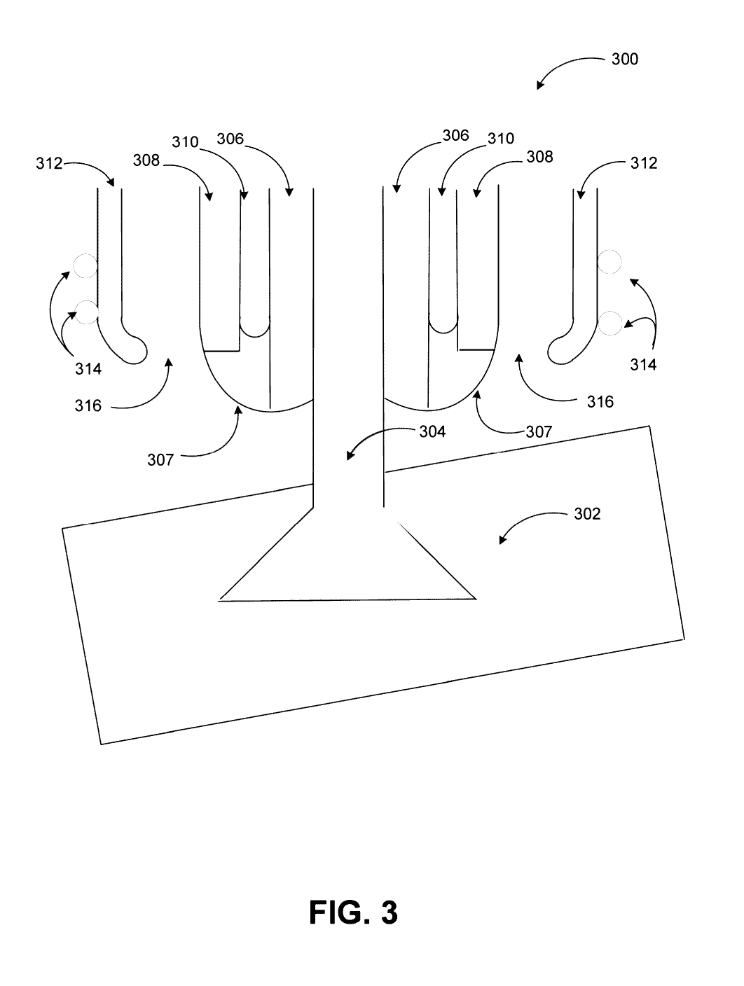

FIG. 3 illustrates a cross-section of an extrusion nozzle in a 3D printing system, arranged in accordance with at least some embodiments described herein. As shown in a diagram 300, an extrusion nozzle may include a vacuum-insulated tube having a center tube 306 and a second tube 308 surrounding the second tube such that a first annular space 310 between the center tube 306 and the second tube 308 is vacuum-insulated. The center tube 306 and the second tube 308 may be vacuum sealed at a first end and a second end to form the vacuum-insulated tube, for example. Silver solder 307 may be used to vacuum seal the first and second end of the center tube 306 and the second tube 308 together. In other embodiments, the center tube 306 and the second tube 308 may be crimped or welded together at a first end and a second end to form the vacuum-insulated tube. The center tube 306 may be configured to facilitate a flow of resin throughout the center tube in order to deposit a layer of resin onto a surface of a substrate 302 at a substantially high temperature to form a 3D printed article. A fluidity of the resin deposited may be based on a type of resin, a temperature of the resin, and a type of 3D print article. The fluidity may be controlled through a controller of the 3D printing system by varying a flow rate of the resin and/or a temperature of a cooling gas. Once the resin layer is deposited onto the surface of the substrate 302, the resin layer may be rapidly cooled and solidified in the air.

Alternatively, the extrusion nozzle may include a third tube 312 surrounding the second tube 308 that may guide a deposition of a cooling gas onto the resin layer through a second annular space 316 between the second tube 308 and the third tube 312 in order to rapidly solidify the resin layer. A speed at which the layer of resin is deposited onto the surface of the substrate in relation to a speed at which the cooling gas is deposited onto the resin layer at the surface of the substrate may be coordinated by the controller of the 3D printing system. The flow of cooling gas may allow a higher rate of resin deposition and more-rapid fabrication.

One or more resistance heater wires 314 may be wound around the third tube 312 near a tip region of the second tube 308 in a helical manner. Although the center tube 306 of the vacuum-insulated tube may maintain the resin at a substantially high temperature, the resin within the center tube 306 may congeal between resin depositions. The resistance heater wires 314 may resolve this problem by providing heat in order to maintain the flowing resin at a substantially constant temperature in between the resin depositions. In some embodiments, resistance heater wires may also be wound around the second tube 308 (not shown in FIG. 3). Heat may alternatively be provided by forcing electrical current to flow through the center tube 306, with an electric circuit being completed by the second tube 308 and/or the third tube 312 (not shown in FIG. 3).

In some embodiments, a resin tower 304 may be formed using the extrusion nozzle. The resin tower 304 may be formed by depositing high temperature resin through the center tube, while at the same time slowly retracting the center tube 306, the second tube 308, and the third tube 312 away from the substrate 302. When a deposition speed equals a retraction speed, the resin tower 304 may have a diameter equal to an inner diameter of the center tube 306. When the deposition speed is relatively greater than the retraction speed, the diameter of the resin tower 304 may be slightly larger, and when the extrusion speed is relatively less than the retraction speed, the diameter of the resin tower 304 may be slightly smaller. If the speed relationship varies throughout resin deposition, the resin tower 304 may vary in diameter along its length. For example, the resin tower 304 may have a larger diameter at a base near the surface of the substrate 302 for increased lateral stiffness, as illustrated in FIG. 3. When the resin tower 304 has reached a desired height, the extrusion nozzle may be moved upward quickly while reducing the flow of resin from the center tube 306, causing the resin tower 304 to neck. Then, further upward motion may break the neck, separating the extrusion nozzle and the resin tower 304.

The resin tower 304 formed in the example embodiment above may have a high mechanical strength and may be smooth and straight because the resin tower 304 is continuously extruded rather than formed by depositing pellets onto a cold substrate as in current 3D printheads. The resin tower 304 may also be formed to a taller height as the deposition process need not exert any compressive forces on a portion of the tower already completed. In comparison, deposition processes employed by current printheads may exert compressive forces, which when exerted, limit the height of the resin tower because a tall, thin tower may collapse under compression.

In other examples, curvilinear shapes such as a helical spring shape may be formed. The curvilinear shapes may be formed by moving the center tube 306, the second tube 308, and the third tube 312 laterally while depositing the resin from the center tube 306 onto the surface of the substrate 302 or in space above the substrate 302. Similar to the resin tower discussed above, the curvilinear shapes may be formed taller as the deposition process need not exert any compressive forces on a portion of the helical spring already completed.

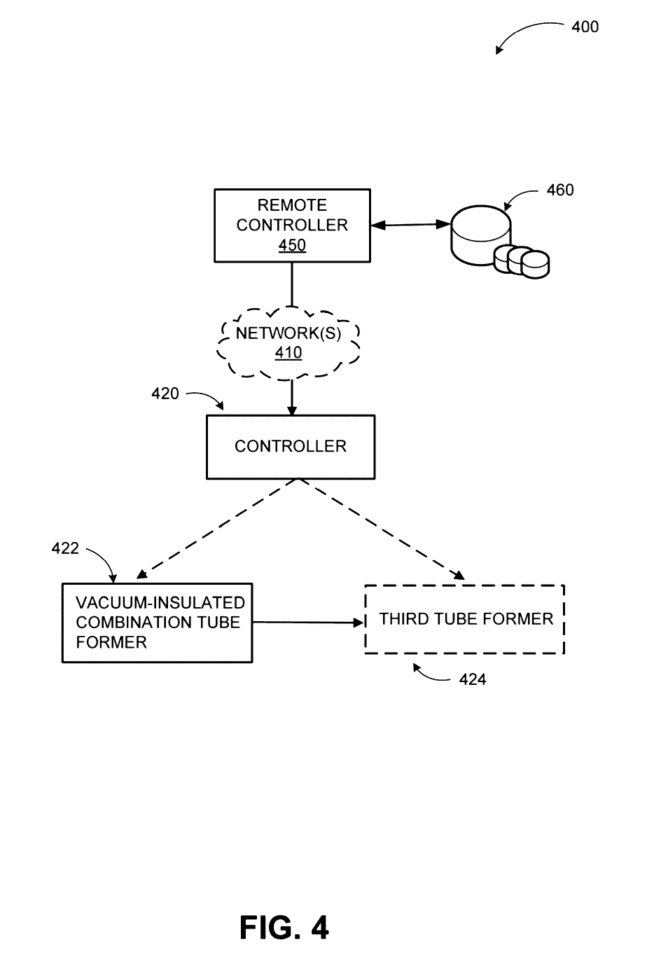

FIG. 4 illustrates a system to fabricate an extrusion nozzle, arranged in accordance with at least some embodiments described herein.

As depicted, system 400 may include at least one controller 420, at least one vacuum-insulated combination tube former 422, and at least one third tube former 424. The controller 420 may be operated by human control or may be configured for automatic operation, or may be directed by a remote controller 450 through at least one network (for example, via network 410). Data associated with controlling the different processes of tube formation may be stored at and/or received from data stores 460.

The controller 420 may include or control the vacuum-insulated combination tube former 422 configured to form a vacuum-insulated combination tube. The controller 420 may also include or control an optional third tube former 424 configured to form a third tube surrounding the vacuum-insulated combination tube.

The vacuum-insulated combination tube former 422 may be configured to form a vacuum-insulated combination tube having a center tube and a second tube surrounding the center tube, where a first annular space between the center and second tube is vacuum-insulated. The center and second tube may be vacuum sealed, for example, crimped, soldered, or welded together at a first end and a second end to form the vacuum-insulated combination tube. The tubes may be composed of hypodermic stainless steel tubing, glass tubing, or non-hypodermic and non-stainless steel tubing composed of any strong metal, where, as on possibility, the tubing has relatively low thermal conductivity. The tubing may be as small in diameter as possible to provide a greater flexibility of the extrusion nozzle for deposition of resin and may also be a limited length based on a viscosity-friction resistance of the resin to prevent a high pressure from being needed to force the resin through the tubing. If the nozzle is made as telescoping tubing as discussed in the next paragraph, then a small orifice at the tip may be combined with larger internal diameters away from the tip, which may permit easier flow of resin through the entire nozzle and permit the nozzle to be longer, for a given nozzle tip orifice diameter, than would otherwise be permitted with non-telescoping or uniform-internal-diameter tubing.

In some embodiments, the vacuum-insulated combination tube former 422 may form the center tube and second tube as a set of telescoping tubes prior to vacuum sealing, crimping, soldering, or welding together the center and second tube. Each tube in the set of telescoping tubes may be vacuum-sealed to an adjacent tube in a same set of telescoping tubes in a similar manner to the vacuum seal of the center and second tube.

The center tube of the vacuum-insulated combination tube formed may be configured to facilitate a flow of resin through the center tube in order to deposit a layer of resin onto a surface of a substrate in order to form a 3D printed article. A vacuum strength in the first annular space between the center and second tube may be selected during formation such that a temperature of the resin in the center tube remains substantially constant throughout the center tube during deposition of the resin. The vacuum insulation, and optionally the relatively low thermal conductivity of the tubing used, may allow the resin layer to be deposited from the center tube of the extrusion nozzle at a substantially constant high temperature, despite a high surface-to-volume ratio of the center tube and resin accumulated within the center tube. Once the resin layer is deposited onto the surface of the substrate, the resin layer may be rapidly cooled and solidified in the air.

Alternatively, the optional third tube former 424 may form a third tube to surround the second tube of the vacuum-insulated combination tube such that a second annular space between the second tube and the third tube is configured to facilitate a flow of cooling gas. The third tube, similar to the center tube and second tube, may be composed of hypodermic stainless steel tubing, glass tubing, or non-hypodermic and non-stainless steel tubing composed of generally any metal or other material. The cooling gas may be deposited at the surface of the substrate to rapidly solidify the deposited resin layer. In some examples, the third tube former 424 may wind one or more resistance heater wires around the third tube near a tip region of the second tube in a helical manner to provide heat in order to maintain the flowing resin at a substantially constant temperature in between depositions.

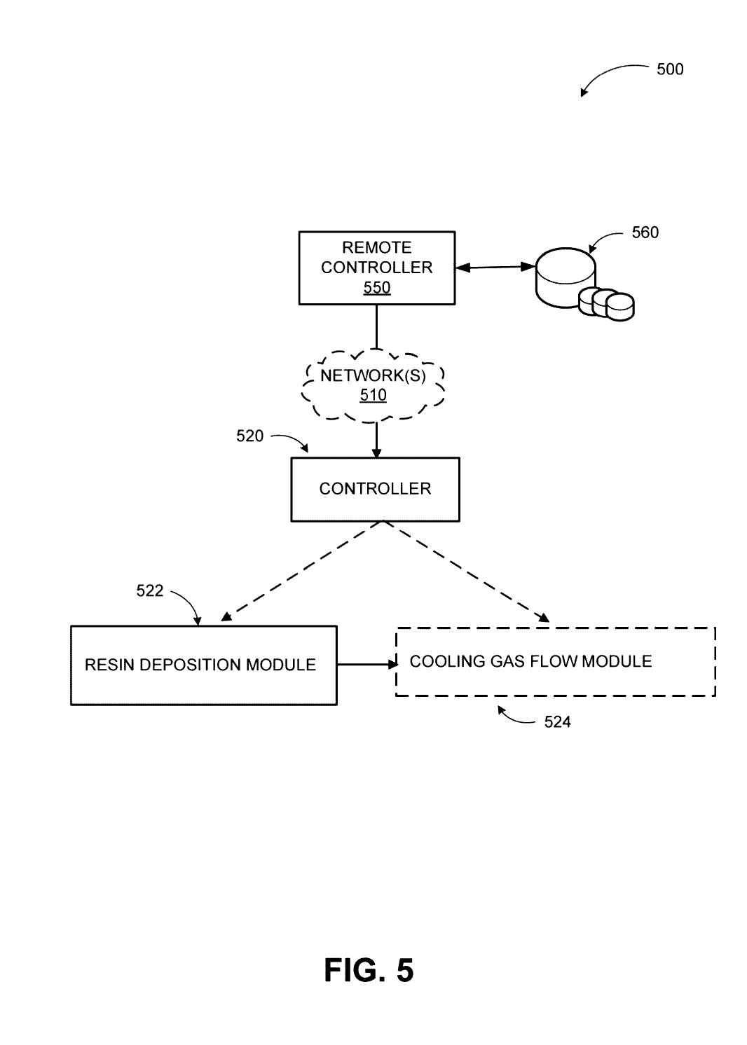

FIG. 5 illustrates a system to employ an extrusion nozzle in a 3D printing system to form a 3D printed article, arranged in accordance with at least some embodiments described herein.

As depicted, system 500 may include at least one controller 520, at least one resin deposition module 522, and at least one optional cooling gas flow module 524. The controller 520 may be operated by human control or may be configured for automatic operation, or may be directed by a remote controller 550 through at least one network (for example, via network 510). Data associated with controlling the different processes of resin deposition and cooling gas flow may be stored at and/or received from data stores 560.

The controller 520 may include or control the resin deposition module 522 configured to deposit a layer of the resin onto a surface of a substrate through a vacuum-insulated center tube of an extrusion nozzle. The vacuum-insulated tube may include a center tube and surrounding second tube arranged such that a first annular space between the center tube and the second tube is vacuum-insulated. The controller 520 may also include and/or control the cooling gas flow module 524 configured to deposit a cooling gas onto the layer of resin at the surface of the substrate.

The resin deposition module 522, managed by the controller 520, may deposit the layer of the resin onto the surface of a substrate through the center tube of the extrusion nozzle in order to form a 3D printed article. A flow of resin may be facilitated in the center tube between depositions, where the vacuum insulation of the first annular space may be selected such that a temperature of the resin may be maintained at a substantially constant temperature throughout the center tube, or, such that the resin is extruded at a predetermined temperature. The controller 520 may be configured to control a fluidity of the resin deposited based on a type of resin, a temperature of the resin, and a type of 3D print article by varying a flow rate of the resin and/or a temperature of a cooling gas.

In some embodiments, the cooling gas flow module 524, managed by the controller 520 may be configured to deposit a cooling gas onto the layer of resin at the surface of the substrate through a second annular space between the second tube and a third tube surrounding the second tube, to rapidly solidify the layer of resin. The controller 520 may be further configured to coordinate a speed at which the layer of resin is deposited onto the surface of the substrate in relation to a speed at which the cooling gas is deposited onto the resin layer at the surface of the substrate.

The examples in FIGS. 1 through 5 have been described using specific apparatuses, configurations, and systems to employ an extrusion nozzle in 3D printing systems to form a 3D printed article. Embodiments to form the 3D printed article are not limited to the specific apparatuses, configurations, and systems according to these examples.

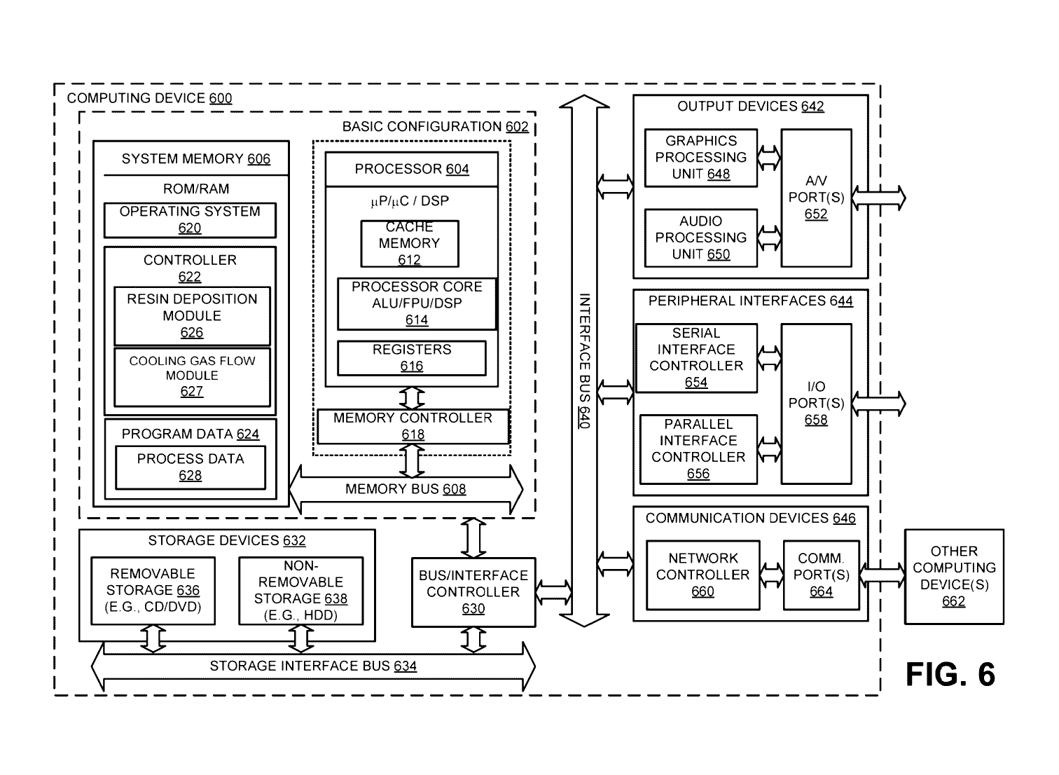

FIG. 6 illustrates a general purpose computing device, which may be used to form a 3D printed article employing an extrusion nozzle in a 3D printing system, arranged in accordance with at least some embodiments described herein.

For example, the computing device 600 may be used as a server, desktop computer, portable computer, smart phone, special purpose computer, or similar device such as a controller, a new component, a cluster of existing components in an operational system including a vehicle and a smart dwelling. In an example basic configuration 602, the computing device 600 may include one or more processors 604 and a system memory 606. A memory bus 608 may be used for communicating between the processor 604 and the system memory 606. The basic configuration 602 is illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations the memory controller 618 may be an internal part of the processor 604.

Depending on the desired configuration, the system memory 606 may be of any type including but not limited to volatile memory (such as RAM), non-volatile memory (such as ROM, flash memory, etc.) or any combination thereof. The system memory 606 may include an operating system 620, an application 622, and program data 624. The application 622 may include a resin deposition module 626 and a cooling gas flow module 627, which may be an integral part of the application or a separate application on its own. The resin deposition module 626 may be configured to deposit a layer of resin onto a surface of a substrate through a vacuum-insulated center tube of an extrusion nozzle. The cooling gas flow module 627 may be configured to deposit a cooling gas onto the deposited layer of resin at the surface of the substrate. The program data 624 may include, among other data, process data 628 related to control of resin deposition and cooling gas flow, as described herein.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 646) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example communication device 646 includes a network controller 660, which may be arranged to facilitate communications with one or more other computing devices 662 over a network communication link via one or more communication ports 664. The one or more other computing devices 662 may include servers, client devices, and comparable devices, or, for example, servomotors, stepmotors, or the like controlling a position and orientation of the extrusion nozzle 112 of FIG. 1 (or, intermediate circuits such as processors or amplifiers coupled to such servomotors, stepmotors, or the like).

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (1R) and other wireless media. The term computer readable media as used herein may include both storage media and communication media.

The computing device 600 may be implemented as a part of a general purpose or specialized server, mainframe, or similar computer that includes any of the above functions. The computing device 600 may also be implemented as a personal computer including both laptop computer and non-laptop computer configurations.

Example embodiments may also include employment of an extrusion nozzle in 3D printing systems to form a 3D printed article. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

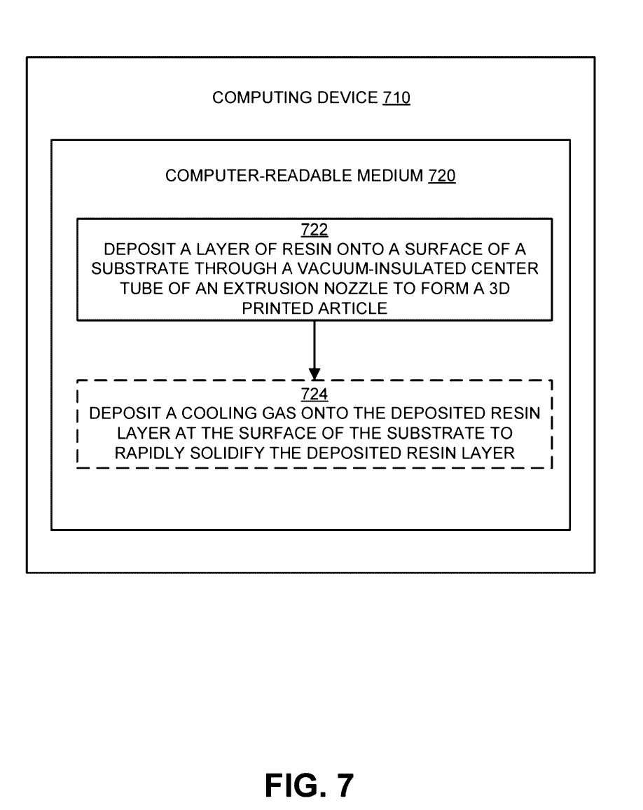

FIG. 7 is a flow diagram illustrating an example method to form a 3D printed article employing an extrusion nozzle in a 3D printing system that may be performed by a computing device such as the computing device in FIG. 5, arranged in accordance with at least some embodiments described herein.

Example methods may include one or more operations, functions or actions as illustrated by one or more of blocks 722 and/or 724. The operations described in the blocks 722 through 724 may also be stored as computer-executable instructions in a computer-readable medium such as a computer-readable medium 720 of a computing device 710.

An example process to employ an extrusion nozzle in a 3D printing system to form 3D printed article may begin with block 722, “DEPOSIT A LAYER OF RESIN ONTO A SURFACE OF A SUBSTRATE THROUGH A VACUUM-INSULATED CENTER TUBE OF AN EXTRUSION NOZZLE TO FORM A 3D PRINTED ARTICLE,” where a controller of the 3D printing system may be configured to manage deposition of the resin layer onto a surface of a substrate through a vacuum-insulated center tube of the extrusion nozzle. The extrusion nozzle may include a vacuum-insulated tube having the center tube having an interior of an elongated Dewar flask and a second tube surrounding the center tube such that a first annular space between the center tube and the second tube is vacuum-insulated. A vacuum strength in the first annular space between the center tube and the second tube may be selected such that a temperature of the resin in the center tube remains substantially constant throughout the center tube during deposition of the resin (or remains sufficiently high), despite a distance from the extrusion nozzle to an initial heat source of the resin. The controller may be configured to control a fluidity of the resin deposited based on a type of resin, a temperature of the resin, and/or a type of 3D print article, by varying a flow rate and/or a temperature of a cooling gas. The controller may also be configured to position a tip of the center tube, such as in a cavity, crevice, or trough of the substrate. The controller may further be configured to tilt the extrusion nozzle to deposit the resin layer onto a surface of a substrate that is non-horizontal, non-parallel to a substrate support base, and/or non-parallel to a track by which the extrusion nozzle is moved.

Block 722 may be followed by optional block 724, “DEPOSIT A COOLING GAS ONTO THE DEPOSITED RESIN LAYER AT THE SURFACE OF THE SUBSTRATE TO RAPIDLY SOLIDIFY THE DEPOSITED RESIN LAYER,” where the controller of the 3D printing system is further configured to manage deposition of a cooling gas onto the deposited resin layer at the surface of the substrate. The cooling gas may be deposited through a second annular space between the second tube and a third tube surrounding the second tube. The controller may further be configured to coordinate a speed at which the cooling gas is deposited in relation to a speed at which the resin is deposited.

The blocks included in the above described process are for illustration purposes. Employment of an extrusion nozzle in a 3D printing system may be implemented by similar processes with fewer or additional blocks. In some embodiments, the blocks may be performed in a different order. In some other embodiments, various blocks may be eliminated. In still other embodiments, various blocks may be divided into additional blocks, or combined together into fewer blocks.

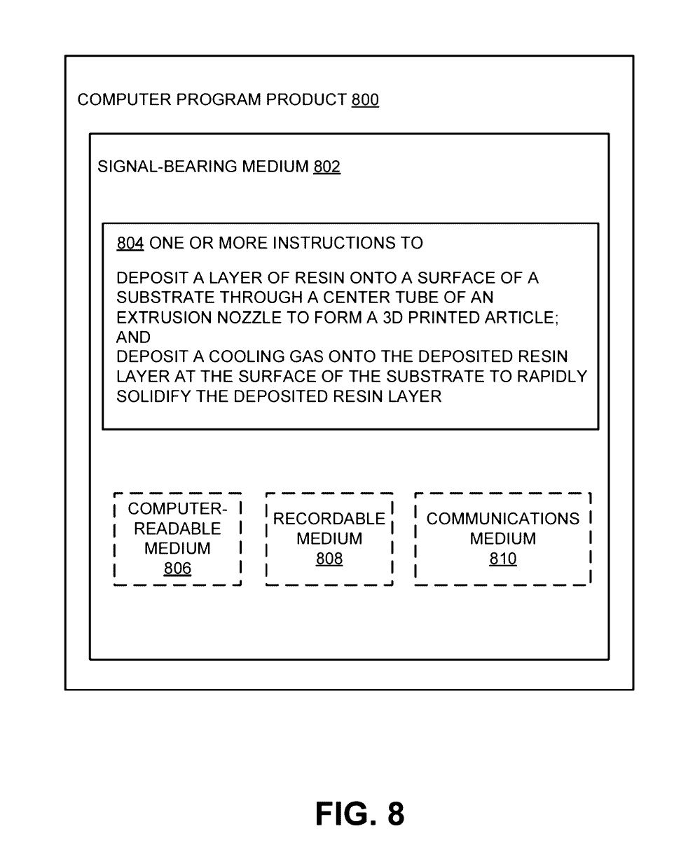

FIG. 8 illustrates a block diagram of an example computer program product, arranged in accordance with at least some embodiments described herein.

In some embodiments, as shown in FIG. 8, the computer program product 800 may include a signal bearing medium 802 that may also include one or more machine readable instructions 804 that, when executed by, for example, a processor, may provide the functionality described herein. Thus, for example, referring to the processor 604 in FIG. 6, a resin deposition module 626 and a cooling gas flow module 627 executed on the processor 604 may undertake one or more of the tasks shown in FIG. 8 in response to the instructions 804 conveyed to the processor 604 by the medium 802 to perform actions associated with employment of an extrusion nozzle in a 3D printing system as described herein. Some of those instructions may include, for example, one or more instructions to deposit a layer of resin onto a surface of a substrate through a vacuum-insulated center tube of an extrusion nozzle to form a 3D printed article, and optionally to deposit a cooling gas onto the deposited resin layer through at the surface of the substrate to rapidly solidify the deposited resin layer, according to some embodiments described herein.

In some implementations, the signal bearing medium 802 depicted in FIG. 8 may encompass a computer-readable medium 806, such as, but not limited to, a hard disk drive, a solid state drive, a Compact Disc (CD), a Digital Versatile Disk (DVD), a digital tape, memory, etc. In some implementations, the signal bearing medium 802 may encompass a recordable medium 808, such as, but not limited to, memory, read/write (R/W) CDs, R/W DVDs, etc. In some implementations, the signal bearing medium 802 may encompass a communications medium 810, such as, but not limited to, a digital and/or an analog communication medium (for example, a fiber optic cable, a waveguide, a wired communications link, a wireless communication link, etc.). Thus, for example, the program product 800 may be conveyed to one or more modules of the processor 604 of FIG. 6 by an RF signal bearing medium, where the signal bearing medium 802 is conveyed by the wireless communications medium 810 (for example, a wireless communications medium conforming with the IEEE 802.11 standard).

According to some examples, extrusion nozzles for a 3D printing system are described. An example extrusion nozzle may include a vacuum-insulated tube having a center tube configured to facilitate a flow of resin therethrough from a first end to a second end thereof, and a second tube surrounding the center tube, where the second tube and the center tube may be arranged such that a first annular space between the center tube and the second tube is vacuum-insulated. The example extrusion nozzle may also include a controller configured to manage a deposition of a layer of the resin onto a surface of a substrate through the center tube.

In other examples, a third tube may be configured to surround the second tube and guide a deposition of a cooling gas onto the resin layer through a second annular space between the second tube and the third tube to rapidly solidify the resin layer. One or more resistance heater wires may be wound around the third tube near a tip region of the second tube, the resistance heater wires being configured to provide heat in order to maintain the flowing resin at a substantially constant temperature. The resistance heater wires may be wound around the third tube in a helical manner. The center tube may include an interior of an elongated Dewar flask.

In further examples, the center tube and the second tube may be vacuum sealed, crimped, soldered, or welded together at a first end and a second end to form a vacuum-insulated combination tube. The center tube and the second tube may be vacuum sealed together with an epoxy, a silver solder, and/or glass. The center tube and the second tube may be composed of hypodermic stainless steel, metal, or glass tubing. The center tube and the second tube may form a set of telescoping tubes, where each tube outside of an inner tube in the set of telescoping tubes may be more rigid than the inner tube, and may have a lower resistance to a flow of resin than the inner tube. The center tube and the second tube may be configured as an attachable and de-attachable extension of a printhead of the 3D printing system. The center tube and the second tube may be incorporated into a printhead of the 3D printing system.

According to some embodiments, methods of using an extrusion nozzle in a 3D printing system are provided. An example method may include depositing a layer of resin onto a surface of a substrate through a center tube of the extrusion nozzle, where a second tube surrounding the center tube may be coupled to the center tube such that a first annular space between the center tube and the second tube is vacuum-insulated.

In other embodiments, a vacuum strength may be selected in the first annular space such that a temperature of the resin in the center tube remains substantially constant throughout the center tube, during the depositing step. Electrical current may be applied through the center tube to provide heat such that the resin in the center tube remains at a substantially high temperature throughout the center tube. A cooling gas may be deposited onto the resin layer at the surface of the substrate through a second annular space between the second tube and a third tube surrounding the second tube to rapidly solidify the resin layer. A speed at which the layer of resin is deposited onto the surface of the substrate may be coordinated in relation to a speed at which the cooling gas is deposited onto the resin layer at the surface of the substrate.

In further embodiments, a fluidity of the resin deposited onto the resin layer at the surface of the substrate may be controlled by selecting a type of resin, a temperature of the resin, and/or a type of 3D print article, and by varying a flow rate and/or a temperature of the cooling gas. A resin tower may be formed on the surface of the substrate by depositing resin from the center tube while simultaneously retracting the center tube and the second tube of the extrusion nozzle from the surface of the substrate. The extrusion nozzle may be tilted to deposit a layer of resin onto a surface of a substrate that is non-horizontal, non-parallel to a substrate support base, and/or non-parallel to a track by which the extrusion nozzle is moved. A tip of the extrusion nozzle may be positioned into a cavity, crevice, or trough of the substrate.

According to some examples, 3D printing systems are described. An example system may include a resin deposition module configured to deposit a layer of resin onto a surface of a substrate through a vacuum-insulated center tube of an extrusion nozzle, where a second tube surrounding the center tube may be coupled to the center tube such that a first annular space between the center tube and the second tube is vacuum-insulated. The example system may also include a controller configured to coordinate operations of the resin deposition module.

In other examples, the example system may include a cooling gas flow module configured to deposit a cooling gas onto the layer of resin at the surface of the substrate through a second annular space between the second tube and a third tube surrounding the second tube, to solidify the layer of resin. The controller may be further configured to coordinate a speed at which the layer of resin is deposited onto the surface of the substrate in relation to a speed at which the cooling gas is blown onto the resin layer at the surface of the substrate. The controller may be further configured to position a tip of the center tube, where the tip of the center tube may be positioned into a cavity, crevice, or trough of the substrate. The controller may be further configured to select a fluidity of the resin based on a type of resin, a temperature of the resin, and/or a type of 3D print article, by varying a flow rate and/or a temperature of the cooling gas.

According to some embodiments, methods to fabricate an extrusion nozzle for a 3D printing system are provided. An example method may include forming a vacuum-insulated combination tube having a center tube configured to facilitate a flow of resin therethrough from a first end to a second end thereof, and a second tube surrounding the center tube, where the second tube and the center tube may be arranged such that a first annular space between the center tube and the second tube is vacuum-insulated. The example method may also include forming a third tube to surround the second tube such that a second annular space between the second tube and the third tube may be configured to facilitate a flow of cooling gas.

In other embodiments, forming the vacuum-insulated combination tube may include vacuum sealing, crimping, soldering, or welding together the center tube and the second tube at a first end and a second end of the center tube and the second tube. One or more resistance heater wires may be wound around the third tube near a tip region of the second tube, the resistance heater wires being configured to provide heat in order to maintain the flowing resin at a substantially constant temperature. The center tube, the second tube, and the third tube may be configured as an attachable and de-attachable extension of a printhead of the 3D printing system. The center tube, the second tube, and the third tube may be incorporated into a printhead of the 3D printing system.

According to some examples, a computer-readable storage medium with instructions stored thereon to use an extrusion nozzle in a three-dimensional (3D) printing system may be described. The instructions may cause a method, similar to the methods provided above, to be performed when executed.

### Examples

Following are illustrative examples of how some embodiments may be implemented, and are not intended to limit the scope of embodiments in any way.

### Example 1

### An Extrusion Nozzle Incorporated into a Printhead

An extrusion nozzle including a vacuum-insulated combination tube may be incorporated into a main forming head of a 3D printer. The vacuum-insulated combination tube may include a center tube and a second tube. The center tube may be a 30-gauge hypodermic needle-type stainless steel tubing with an inside diameter (ID) of 0.16 mm and an outside diameter (OD) of 0.31 mm. Surrounding the center tube may be a second tube of a same material, but in gauge 23, with an ID of 0.34 mm and an OD of 0.64 mm. The center and second tube may be arranged such that a first annular space between the center and second tube is vacuum-insulated. For example, the center and second tube may be vacuum-sealed together at a first end and a second end using an epoxy.

The center tube of the vacuum-insulated combination tube may be configured to facilitate a flow of resin through the center tube to deposit a layer of resin onto a surface of a substrate in order to form a 3D printed article. A vacuum strength in the first annular space between the center and second tube may be selected such that a temperature of the resin in the center tube remains substantially constant throughout the center tube during deposition of the resin. The vacuum insulation and secondarily a relatively low thermal conductivity of the hypodermic needle-type stainless steel tubing used may allow the resin layer to be deposited from the center tube of the extrusion nozzle at a substantially high temperature, despite a high surface-to-volume ratio of the center tube and the resin accumulated within the center tube. Due to the incorporation of the extrusion nozzle into the main forming head of a 3D printer, the resin deposition action may be mostly horizontal.

### Example 2

### An Extrusion Nozzle as an Attachable and De-Attachable Extension of a Printhead

An extrusion nozzle including a vacuum-insulated combination tube may be an attachable and de-attachable extension of a main forming head of a 3D printer. The vacuum-insulated combination tube may include a center tube and a second tube. The center tube may be a 35-gauge glass tubing, with an inside diameter (ID) of 0.064 mm and an outside diameter (OD) of 0.15 mm. Surrounding the center tube may be a second tube of a same material, but in gauge 28, with an ID of 0.18 mm and an OD of 0.36 mm. The center and second tube may be arranged such that a first annular space between the center and second tube is vacuum-insulated. For example, the center and second tube may be welded or soldered together at a first end and a second end.

Furthermore, the center and second tubes may form a set of telescoping tubes. For example, a first tube in the set of telescoping tubes may be the center tube, and may be made of the 35-gauge glass tubing with the ID of 0.064 mm and OD of 0.15 mm. An adjacent tube surrounding the first tube may be 30-gauge glass tubing with an ID slightly greater than the 0.15 mm OD of the first tube and an OD of 0.31 mm. The first tube and the surrounding adjacent tube may be welded together in at a first end and a second end to form vacuum-insulated telescoping tubes. The adjacent tube may be similarly welded to another outer adjacent tube surrounding the adjacent tube. The other outer adjacent tube may be 23-gauge glass tubing with an ID of 0.43 mm.

The center tube of the vacuum-insulated combination tube may be configured to facilitate a flow of resin through the center tube to deposit a layer of resin onto a surface of a substrate in order to form a 3D printed article. A vacuum strength in the first annular space between the center and second tube may be selected such that a temperature of the resin in the center tube remains substantially constant throughout the center tube during deposition of the resin. The vacuum insulation and a relatively low thermal conductivity of the glass tubing used may allow the resin layer to be deposited from the center tube of the extrusion nozzle at a substantially high temperature, despite a high surface-to-volume ratio of the center tube and resin accumulated within the center tube. Furthermore, due to the vacuum insulation, the resin may remain at a substantially high temperature throughout the center tube, despite a potential distance from an initial heat source to the extrusion nozzle as the resin flows from the heat source to a tip of the center tube to be deposited. This may allow the extrusion nozzle to be positioned far from a main forming head of a 3D printer, where the heat source may be located. The flexibility of the extrusion nozzle, due to the small diameter of the vacuum-insulated tube and the ability to attach and detach from the main forming head of the 3D printer, may allow resin to be deposited horizontally on a surface of a substrate and/or vertically into crevice, cavities, and/or troughs of the substrate. The extrusion nozzle may also be tilted to deposit resin on a surface of a substrate that is non-horizontal, non-parallel to a substrate support base, or non-parallel to a track by which the extrusion nozzle is moved.

### Example 3

### An Extrusion Nozzle Configured to Form a Resin Tower

An extrusion nozzle including a vacuum-insulated combination tube may be configured to form a resin tower. The vacuum-insulated combination tube may include a center tube and a second tube. The center tube may be a 33-gauge non-hypodermic titanium tubing, with an ID of 0.11 mm and an OD of 0.21 mm. Surrounding the center tube may be a second tube of a same material, but in gauge 26, with an ID of 0.26 mm and an OD of 0.46 mm. The center and second tube may be arranged such that a first annular space between the center and second tube is vacuum-insulated. For example, the center and second tube may be crimped together at a first end and a second end. The center tube may be configured to facilitate a flow of resin through the center tube between resin depositions, where the vacuum insulation of the first annular space may be selected such that a temperature of the resin may be maintained at a substantially constant temperature throughout the center tube.

The extrusion nozzle may also include a third tube that surrounds the second tube to guide a deposition of a cooling gas onto the resin layer through a second annular space between the second tube and the third tube to rapidly solidify the deposited resin layer. The third tube may be of the same material, but in gauge 21, with an ID greater than 0.46 mm. A speed at which the layer of resin is deposited onto the surface of the substrate may be coordinated in relation to a speed at which the cooling gas is deposited onto the resin layer at the surface of the substrate.

A resin tower, having a same diameter as the ID of the center tube, may be formed by depositing high temperature resin from the center tube while simultaneously retracting the center, second, and third tubes slowly away from a substrate on which the resin tower is being formed. When a deposition speed equals a retraction speed, the resin tower may have a diameter equal to the ID of the center tube, 0.064 mm. When the deposition speed is relatively greater than the retraction speed, the resin tower diameter may be slightly larger, and when the deposition speed is relatively less, the resin tower diameter may be slightly smaller. The diameter may vary from slightly larger to smaller to a degree of hundredths of a millimeter. If the speed relationship varies, the tower may vary in diameter along its length. When the resin tower has reached the desired height, the extrusion nozzle may be moved upward quickly while reducing the flow of resin, causing the resin tower to neck. Then, further upward motion may break the neck, separating the extrusion nozzle and the resin tower.

There are various vehicles by which processes and/or systems and/or other technologies described herein may be effected (for example, hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

While various compositions, methods, systems, and devices are described in terms of “comprising” various components or steps (interpreted as meaning “including, but not limited to”), the compositions, methods, systems, and devices can also “consist essentially of” or “consist of” the various components and steps, and such terminology should be interpreted as defining essentially closed-member groups.”

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, some aspects of the embodiments disclosed herein, in whole or in part, may be equivalently implemented in integrated circuits, as one or more computer programs running on one or more computers (for example, as one or more programs running on one or more computer systems), as one or more programs running on one or more processors (for example as one or more programs running on one or more microprocessors), as firmware, or as virtually any combination thereof, and that designing the circuitry and/or writing the code for the software and or firmware would be possible in light of this disclosure.

The present disclosure is not to be limited in terms of the particular embodiments described in this application, which are intended as illustrations of various aspects. Many modifications and variations can be made without departing from its spirit and scope Functionally equivalent methods and apparatuses within the scope of the disclosure, in addition to those enumerated herein, will be possible from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, systems, or components, which can, of course, vary. It is also to be understood that the terminology used herein is for the purpose of describing particular embodiments only, and is not intended to be limiting.

In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (for example, a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that particular functionality is achieved. Hence, any two components herein combined to achieve a particular functionality may be seen as “associated with” each other such that the particular functionality is achieved, irrespective of architectures or intermediate components. Likewise, any two components so associated may also be viewed as being “operably connected”, or “operably coupled”, to each other to achieve the particular functionality, and any two components capable of being so associated may also be viewed as being “operably couplable”, to each other to achieve the particular functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

1. An extrusion nozzle for a three-dimensional (3D) printing system to deposit a layer of resin onto a surface of a substrate, the extrusion nozzle comprising:
a vacuum-insulated tube comprising:
a center tube configured to facilitate a flow of resin therethrough from a first end to a second end thereof; and
a second tube surrounding the center tube, wherein a first annular space between the center tube and the second tube is vacuum-insulated; and
a third tube configured to surround the vacuum-insulated tube and guide a deposition of a cooling gas onto the resin layer at the surface of the substrate through a second annular space between the vacuum-insulated tube and the third tube to rapidly solidify the resin layer.

2. (canceled)

3. The extrusion nozzle of claim 1, further comprising:
one or more resistance heater wires wound around the third tube near a tip region of the second tube, wherein the resistance heater wires are configured to generate heat in order to maintain the flowing resin at a substantially constant temperature when an electrical current is applied to the resistance heater wires.

4. The extrusion nozzle of claim 3, wherein the resistance heater wires are wound around the third tube in a helical manner.

5. The extrusion nozzle of claim 1, wherein an interior of the center tube is arranged as an elongated Dewar flask.

6.-7. (canceled)

8. The extrusion nozzle of claim 1, wherein the center tube and the second tube are composed of hypodermic stainless steel or glass tubing.

9. The extrusion nozzle of claim 1, wherein the center tube and the second tube are arranged to form a set of telescoping tubes.

10. The extrusion nozzle of claim 9, wherein the center tube is comprised of a first material and the second tube is comprised of a second material, wherein a characteristic rigidity of the second material is greater than a characteristic rigidity of the first material, and a characteristic resistance to a flow of resin of the second tube is lower than a characteristic resistance to a flow of resin of the center tube.

11. The extrusion nozzle of claim 1, wherein the center tube and the second tube are configured as an attachable and de-attachable extension of a printhead of the 3D printing system.

12. The extrusion nozzle of claim 1, wherein the center tube and the second tube are incorporated into a printhead of the 3D printing system.

13. A method to use an extrusion nozzle in a three-dimensional (3D) printing system to deposit a layer of resin onto a surface of a substrate, the method comprising:
depositing the layer of resin onto the surface of the substrate through a center tube surrounded by and coupled to a second tube with a vacuum-insulated first annular space between the center tube and the second tube; and
depositing a cooling gas onto the resin layer at the surface of the substrate through a second annular space between the second tube and a third tube surrounding the second tube to rapidly solidify the resin layer.

14. The method of claim 13, further comprising:
maintaining, by a controller coupled to the extrusion nozzle, a vacuum strength in the first annular space such that a temperature of the resin in the center tube remains substantially constant throughout the center tube during the deposition of the layer of resin.

15. The method of claim 13, wherein depositing the layer of resin further comprises:
providing heat to the resin near a tip region of the center tube.

16. (canceled)

17. The method of claim 13, further comprising:
coordinating, by a controller coupled to the extrusion nozzle, a speed at which the layer of resin is deposited onto the surface of the substrate in relation to a speed at which the cooling gas is deposited onto the resin layer at the surface of the substrate.

18. The method of claim 13, further comprising:
controlling, by a controller coupled to the extrusion nozzle, a fluidity of the resin deposited onto the surface of the substrate by one or more of selecting a type of resin, selecting a temperature of the resin, and selecting a type of 3D print article; and
varying, by the controller, a flow rate and/or a temperature of the cooling gas based on the fluidity of the resin.

19. The method of claim 13, further comprising:
depositing resin from the center tube while simultaneously retracting the center tube and the second tube of the extrusion nozzle from the surface of the substrate to form a resin tower on the surface of the substrate.

20. The method of claim 13, further comprising:
tilting, by a controller coupled to the extrusion nozzle, the extrusion nozzle to deposit a layer of resin onto a surface of a substrate such that the deposited layer of resin is at least one of: non-horizontal, non-parallel to a substrate support base, and non-parallel to a track by which the extrusion nozzle is moved.

21. The method of claim 13, further comprising:
positioning, by a controller coupled to the extrusion nozzle, a tip of the extrusion nozzle into a cavity, crevice, or trough of the substrate.

22. A three-dimensional (3D) printing system to deposit a resin layer onto a surface of a substrate, the system comprising:
an extrusion nozzle comprising:
a center tube surrounded by and coupled to a second tube with a vacuum-insulated first annular space between the center tube and the first tube, and
the second tube surrounded by and coupled to a third tube with a second annular space between the second tube and the third tube;
a resin deposition module coupled to the extrusion nozzle and configured to deposit the layer of resin onto the surface of the substrate through the center tube of the extrusion nozzle;
a cooling gas flow module coupled to the extrusion nozzle and configured to deposit a cooling gas onto the resin layer at the surface of the substrate through the second annular space between the second tube and the third tube of the extrusion nozzle to solidify the resin layer; and
a controller coupled to the extrusion nozzle, the resin deposition module, and the cooling gas module, the controller configured to coordinate operations of the extrusion nozzle, the resin deposition module, and the cooling gas flow module.

23. (canceled)

24. The system of claim 22, wherein the controller is further configured to coordinate a speed at which the layer of resin is deposited onto the surface of the substrate by the resin deposition module in relation to a speed at which the cooling gas is deposited onto the resin layer at the surface of the substrate by the cooling gas flow module.

25. The system of claim 22, wherein the controller is further configured to position a tip of the center tube.

26. The system of claim 25, wherein the tip of the center tube is positioned into a cavity, crevice, or trough of the substrate.

27. The system of claim 22, wherein the controller is further configured to:
select a fluidity of the resin based on one or more of a type of resin, a temperature of the resin, and a type of 3D print article; and
vary a flow rate and/or a temperature of a cooling gas based on the selected fluidity of the resin.

28. A method to fabricate an extrusion nozzle for a three-dimensional (3D) printing system, the method comprising:
forming a vacuum-insulated combination tube from a center tube and a second tube, wherein
the center tube is configured to facilitate a flow of resin therethrough from a first end to a second end thereof; and
the second tube surrounds the center tube such that a first annular space between the center tube and the second tube is vacuum-insulated; and
forming a third tube to surround the vacuum-insulated combination tube such that a second annular space between the vacuum-insulated combination tube and the third tube facilitates a flow of cooling gas onto the resin layer at the surface of the substrate.

29. The method of claim 28, wherein forming the vacuum-insulated combination tube comprises:
one of vacuum sealing, crimping, soldering, or welding together the center tube and the second tube at a first end and a second end of the center tube and the second tube.

30. The method of claim 28, further comprising:
winding one or more resistance heater wires around the third tube near a tip region of the second tube, wherein the resistance heater wires are configured to generate heat in order to maintain the flowing resin at a substantially constant temperature when an electrical current is applied to the resistance heater wires.

31. The method of claim 28, further comprising:
configuring the center tube, the second tube, and the third tube as an attachable and de-attachable extension of a printhead of the 3D printing system.

32. The method of claim 28, further comprising:
incorporating the center tube, the second tube, and the third tube into a printhead of the 3D printing system.

33. (canceled)

34. An extrusion nozzle for a three-dimensional (3D) printing system to deposit a layer of resin onto a surface of a substrate, the extrusion nozzle comprising:
a center tube configured to facilitate a flow of resin therethrough from a first end to a second end thereof onto the surface of the substrate;
a second tube surrounding the center tube, wherein a first annular space between the center tube and the second tube is vacuum-insulated; and
one or more resistance heater wires wound around the second tube to generate heat to maintain the flowing resin through the center tube at a substantially constant temperature when an electrical current is applied to the resistance heater wires.

35. The extrusion nozzle of claim 34, further comprising:
a third tube configured to surround the second tube and guide a deposition of a cooling gas onto the layer of resin through a second annular space between the second tube and the third tube to rapidly solidify the resin layer.

36. The extrusion nozzle of claim 35, further comprising:
one or more additional resistance heater wires wound around the third tube near a tip region of the second tube.

37. The extrusion nozzle of claim 36, wherein the resistance heater wires are wound around the third tube in a helical manner.
